(19) United States
(12) Patent Application Publication
(10) Pub. No.: US 2004/0107802 A1
(43) Pub. Date: Jun. 10, 2004

(54) Unidirectional braking structure of ratchet wrench

(76) Inventor: Chao-Ren Wu, Ta-Li City (TW)

Correspondence Address: CHARLES E. BAXLEY, ESQUIRE, Hart, Baxley, Daniels & Holton, 5 Fl., 59 John St., New York, NY, 10038, US

(21) Appl. No.: 10/313,451

(22) Filed: Dec. 4, 2002

(51) Int. Cl. B25B 13/46

(52) U.S. Cl. 81/61

(57) ABSTRACT

A unidirectional braking structure of a ratchet wrench comprises: a circoid surface with ratchet teeth disposed on the surrounding wall of an accommodating space at the working end of the wrench; a work piece wheel disposed in the accommodating space of said wheel; a plurality of restricting grooves, equidistantly disposed on the work piece wheel corresponding to the circoid surface with ratchet teeth; a plurality of direction restricting members disposed in the restricting grooves one by one, having a wheel teeth latching end to be engaged with the circoid surface with ratchet end; a plurality of springs disposed between the bottom of the restricting groove and the direction restricting member; such structure enables the present invention to enhance the torque of the wrench, reduce the loading of direction restricting member and the probability of damage, and have the merits of facilitating the manufacturing and assembling.

### BACKGROUND OF THE INVENTION

1. Field of the Invention

The present invention relates to a ratchet wrench, more particularly to an improved unidirectional braking structure of a ratchet wrench.

2. Description of the Related Art

In general, the basic structure of a ratchet wrench has an accommodating space at a working end of the body of the ratchet wrench, and comprises a ratchet wheel, and a unidirectional braking structure disposed on a wall corresponding to the accommodating space and teeth of the ratchet wrench. The unidirectional braking structure is to control the wrench to rotate a work piece and resume its position with idle rotation in the reverse direction. For example, such unidirectional braking structure controls the wrench to rotate clockwise, and also drives the ratchet wheel to rotate accordingly. Such ratchet wheel works with work piece to accomplish the objective of tightening or loosening the work piece. On the contrary, when the wrench is rotated counterclockwise, it will not drive the ratchet wheel to rotate, but allow the wrench to resume its position with idle rotation and get ready for the next clockwise rotation.

At present, there are many designs for the unidirectional braking structure, and the inventor of the present invention broke through the traditional structure to provide an evener and more stable structure and restricting force to enhance the torque of the wrench and aim at the objective of extending the life of the wrench to design the following new structure.

A unidirectional braking system of a ratchet wrench according to the present invention is fixed in an accommodating space of a wheel at the working end of the wrench, comprising: a circoid surface with ratchet teeth disposed on the surrounding wall of the working space of the wheel; a work piece wheel disposed in the accommodating space of the wheel and having a smooth circoid surface; a plurality of restricting grooves equidistantly disposed on the wheel corresponding to the work piece wheel and the circoid surface with ratchet teeth; a plurality of direction restricting members, disposed on the bottom of the restricting grooves one by one, and having a wheel teeth latching end corresponding to the circoid surface with ratchet teeth, and the wheel teeth latching end having a plurality of serrations for engaging with the teeth on the circoid surface with ratchet teeth; a plurality of springs disposed on the bottom of the restricting groove one and the back of the direction restricting member one by one; such that the foregoing latching end of the wheel teeth slightly protrudes outside the wheel of the work piece, and is engaged with the circoid surface of the ratchet teeth.

### SUMMARY OF THE INVENTION

The primary objective of the present invention is to provide a unidirectional braking structure of a ratchet wrench, which has a work piece wheel with a plurality of equidistant directional restricting members around the periphery of the work piece wheel, such that the ring surface with ratchet teeth at the working end of the wrench provides an even and stable structure for the restricting force to enhance the torque of the wrench, and the force of the action on the wrench is shared among the restricting members in several directions to reduce the load on the restricting members and the probability of damages as well as extend the life of the wrench.

Another objective of the present invention is to provide a unidirectional braking structure of a ratchet wrench which has the merits of facilitating the manufacturing and assembling.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is an explosive diagram of the unidirectional braking structure of the first preferred embodiment of the present invention.

FIG. 2 is a diagram of the appearance of the assembled unidirectional structure of the first preferred embodiment of the present invention.

FIG. 3 is a cross-sectional diagram of the assembled unidirectional structure of the first preferred embodiment of the present invention.

FIG. 4A is a diagram of the assembled unidirectional structure of the first preferred embodiment of the present invention when the restricting ring is removed.

FIG. 4B is an illustrative diagram of the wrench during its idle rotation as illustrated in FIG. 4A.

FIG. 4C is an enlargement of part of FIG. 4A.

FIG. 5A is a diagram of the assembled unidirectional structure of the second preferred embodiment of the present invention when the restricting ring is removed.

FIG. 5B is an illustrative diagram of the wrench during its idle rotation as illustrated in FIG. 5A.

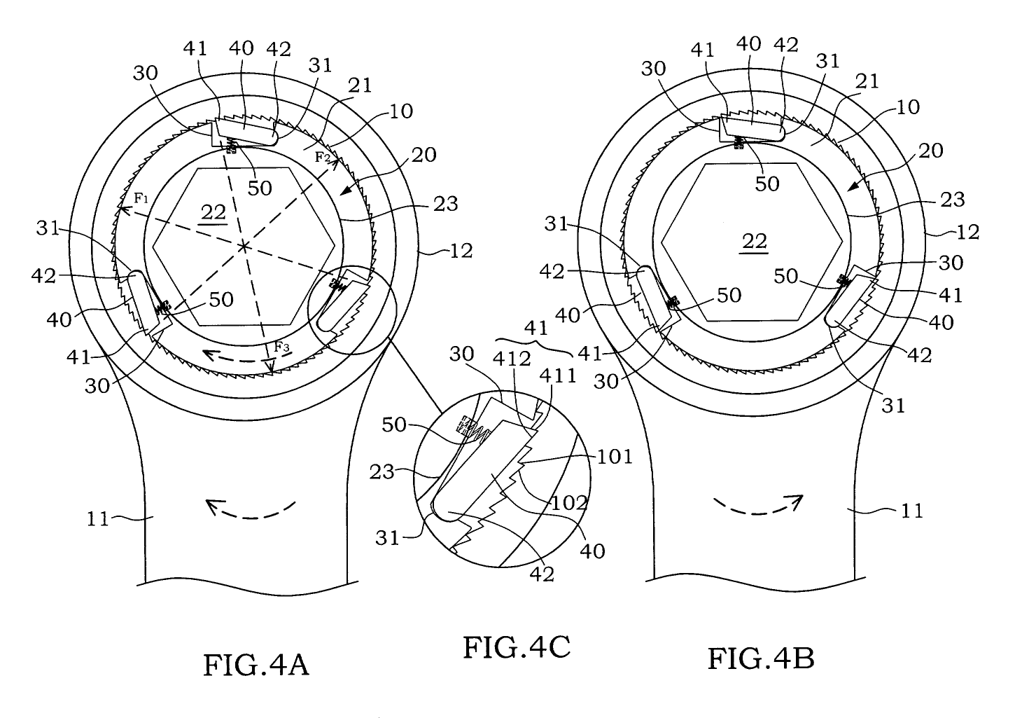

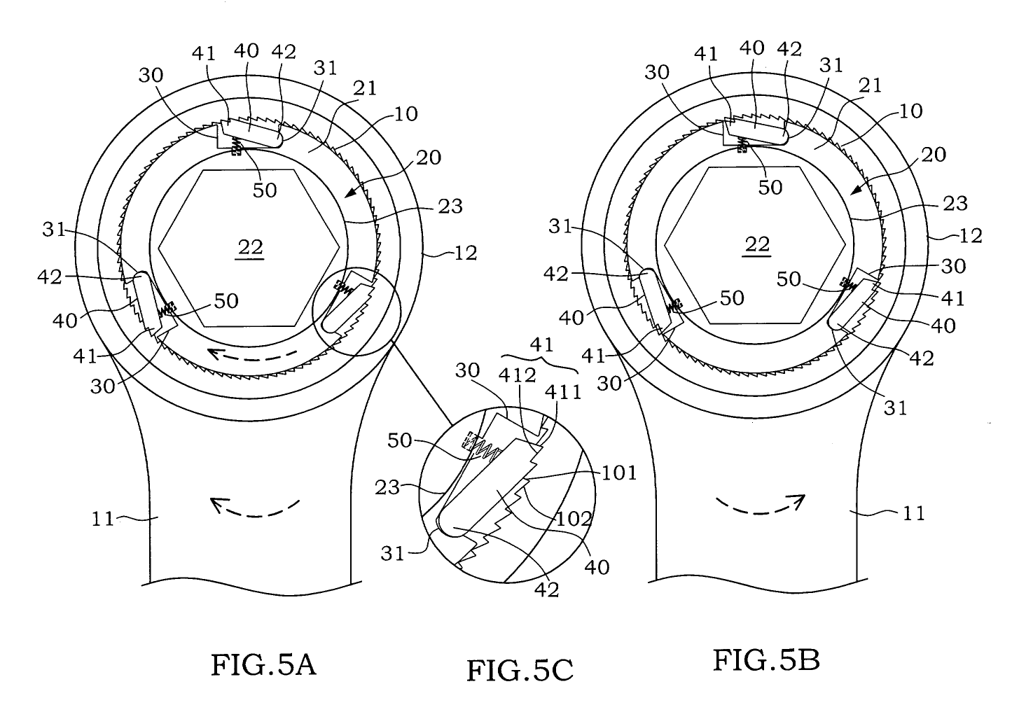

FIG. 4C is an enlargement of part of FIG. 5A.

### DETAILED DESCRIPTION OF THE PREFERRED EMBODIMENTS

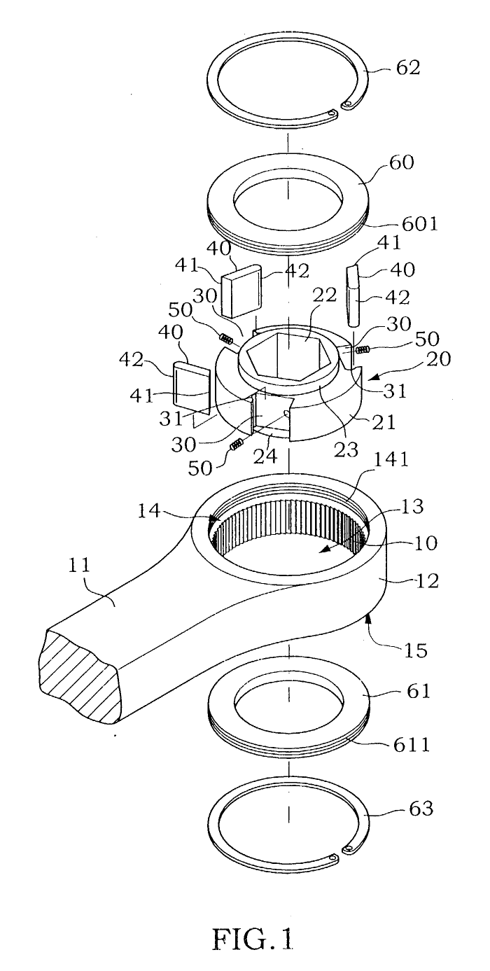

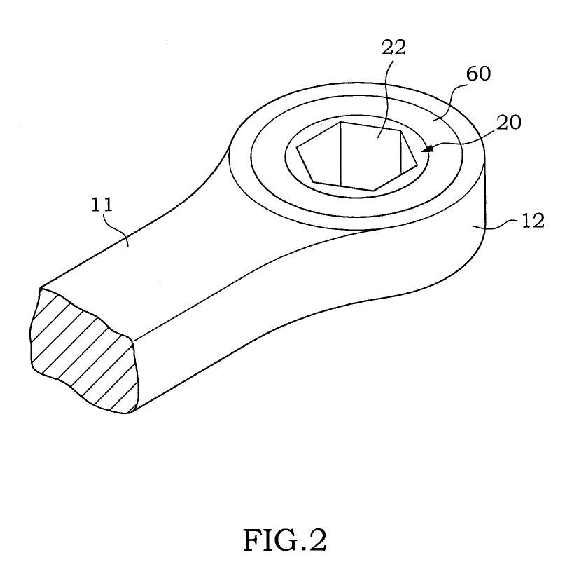

Please refer to FIGS. 1, 2, and 3 for the unidirectional braking structure disposed in the working end 12 of a wrench 11, comprising: a circoid surface with ratchet teeth 10 disposed in the middle section on the surrounding wall of the accommodating space 13 of the wheel at the working end of the wrench 11; two restricting ring accommodating spaces 14, 15 disposed on the upper end and the lower end of the wheel accommodating space are the spaces with the diameter larger than that of the circoid surface with ratchet teeth 10 such the circoid surface with ratchet teeth 10 in protruded inward and disposed in the wheel accommodating space 13; such two restricting ring accommodating spaces 14, 15 having a C-shape circular latching grooves 141, 151 each on the sidewall; a work piece wheel 20 disposed on the foregoing wheel accommodating space 13, and an outwardly protruded wheel 21 is disposed at a position corresponding to the circoid surface with ratchet wheel, and a neck section 23, 24 with a diameter smaller than the foregoing wheel each disposed on the upper and lower ends; the whole exterior of the work piece wheel 20 is a smooth circular surface, and a work piece passing hole 22 disposed at the center for passing the work piece (not shown in the figure); a plurality of restricting grooves 30 equidistantly disposed around the wheel 21 of the piece wheel, which is an open groove at the upper, lower, and lateral sides; a plurality of direction restricting members 40 are disposed in the restricting groove 30 one by one; the direction restricting 40 having a wheel teeth latching end 41 at one of its end and a restricting end at the other end. The wheel latching end 41 has a end corner corresponsive to the circoid surface with ratchet teeth 10, and such end corner has serrations (as shown in FIG. 4A and FIG. 5A engaged with the teeth of the circoid surface with ratchet teeth 10. Such restricting end 42 is an outwardly protruded circular arc, and a protruded arc restricting groove 31 is disposed on the wall corresponsive to the restricting groove 30 and the restricting end 42 such that the restricting end 42 is restricted into the restricting groove 31, but the directional restricting member 40 still slightly swing at the fulcrum of the restricting end 42.

A plurality of springs are disposed on between the bottom of the restricting groove 30 and the wheel teeth latching end 41 one by one, such the wheel teeth latching end 41 slightly protrudes outside the work piece wheel 20 and being engaged with the circoid surface with ratchet teeth.

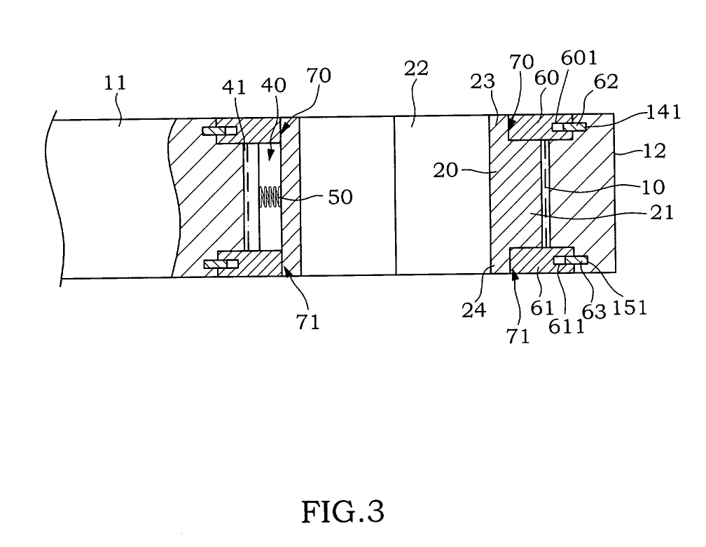

Two restricting rings 60, 61 are the rings with external diameter substantially equal to the restricting ring accommodating space and internal diameter substantially equal to the external diameter of the neck section of the work piece wheel, and a C-shape ringed groove 601, 602 is disposed on its periphery, a C-shape ring is disposed in advance such that when the two restricting rings 60, 61 are disposed in the space between the restricting ring accommodating space 14, 15, and the neck section 23, 24, the C-shape latching ring 62, 63 also latches into the C-shape ring latching groove 141, 151 of the restricting ring accommodating space 14, 15, and the two restricting rings 60, 61 will be fixed in position, and will restrict the work piece wheel into it; a serration engaged with the teeth of the circoid surface with ratchet teeth 10 is disposed at the end corner with respect to the wheel teeth latching end 41 and the circoid surface with ratchet teeth 10. When the wrench 10 is rotated to a direction, the wheel latching end 41 and the circoid surface with ratchet teeth 10 constitute a latching relation, but when the wrench is rotated to another direction, the circoid surface with ratchet teeth 10 will flip open the wheel latching end 41. In the preferred embodiment as shown in FIG. 3C and FIG. 4C, each ratchet teeth groove of the circoid surface with ratchet teeth is constituted by a vertical side 101 and an aslant side 102, and the wheel teeth latching end 41 of the direction restricting member 40 also has a vertical side 411 and an aslant side 412. When the wrench 11 is rotated clockwise as shown in (FIG. 4A and FIG. 5A), the vertical sides 101, 411 of both constitute a latching relation, and thus the wrench will drive the work piece wheel 20 to rotate, and such work piece wheel 20 can drive the work piece to rotate. On the other hand, as shown in FIG. 4B and FIG. 5B, when the wrench is rotated counterclockwise, the work piece wheel 20 is restricted by the tightness of the work piece. The aslant side of the circoid surface with ratchet teeth 10 rotating in the opposite direction flips open the wheel teeth latching end 41 such that the direction restricting member 40 produce a slight swing with the restricting end as the center. Therefore, the counterclockwise rotating wrench 11 will resume its appropriate position with idle rotation to facilitate the next clockwise rotation of the wrench. The serration of the wheel teeth latching end 41 and the circoid surface with ratchet teeth 10 can be any corresponding serrations, and is not just limited to the embodiment shown in the figure only.

The advantages of the structure of the present invention are listed below:

A. The arrangement of the plurality of equidistantly disposed directional restricting members 40 and the latching of the circoid surface with ratchet teeth 10 provides an even and stable latching force for the structure, therefore it can improve the torque of the wrench, and the action of the wrench is shared evenly by the plurality of directional restricting members 40. The present invention reduces the loading of the direction restricting members 40 and the probability of damaging the direction restricting member 40, and thus can extend the life of the wrench.

B. Refer to the previous advantage. When the circoid surface with ratchet teeth 10 and the direction restricting member 40 constitute a latching relation such that the wrench together with the work piece wheel 20 drive the work piece, the engagement of the ratchet teeth has the action along the diameter with the forces F1, F2, F3 becomes a balancing action such that the work piece wheel 20 has a fixed center to reduce the structural crack and damage of the close contact between the wheel 21 and the circoid surface with ratchet teeth 10.

C. The circoid surface with ratchet teeth 10 is inwardly protruded and disposed at the middle section of the wall in the wheel accommodating space 13. Such design facilitates the insertion of the serration of the manufacture knife and thus enhances the convenience and quickness of the manufacture of the serrated surface.

D. Besides the function of fixing the work piece wheel 20 into the wheel accommodating space 13, the two restricting rings 60, 61 also works with the neck section 23, 24 and the accessory supporting surface 70, 71 composed of the accuracy of the internal diameter of the restricting rings 60, 61, and tries to keep the central axis of the work piece wheel 20 and the central axis of the wheel accommodation space 13 at the same position, and fixes the center of the work piece wheel 20. When the above actions F1, F2, F3 are generated, the accessory supporting surface 70, 71 become the primary force exerted surface. Therefore, it can reduce the structural damage of the structural serration caused by the over-tightness between the circoid surface with ratchet teeth and the wheel of the work piece wheel 20.

E. The upper and lower restricting rings 61, 62 fix the work piece wheel 20, and the upper and lower ring surfaces of the restricting rings 61, 62 are aligned with the edge of the working end 12 of the wrench to maintain the flat artistic appearance of the upper and lower surfaces.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

What is claimed is:

1. A unidirectional braking structure of a ratchet wrench, fixed in an accommodating space at a working end of a wheel of the wrench, comprising:
a circoid surface with ratchet teeth, disposed on the surrounding wall of the accommodating space of said wheel;
a work piece wheel, disposed said accommodating space, having a smooth circoid surface;
a plurality of restricting grooves, equidistantly on the work piece wheel corresponding to the circoid surface with ratchet teeth;
a plurality of direction restricting members, one by one disposed in the restricting grooves one by one, and having a wheel teeth latching end to be engaged with the circoid surface with ratchet end, and the wheel teeth latching end having a serration capable of engaging with the teeth on the circoid surface with ratcheted teeth;
a plurality of springs, one by one disposed between the bottom of the restricting groove and the direction restricting member; such that the said latching end of the wheel teeth slightly protruding outside the wheel of the work piece, and being engaged with the circoid surface of the ratchet teeth.

2. A unidirectional braking structure of a ratchet wrench as claimed in claim 1, wherein said circoid surface with ratchet teeth being disposed in the middle section of the surrounding wall of the accommodating space of the wheel.

3. A unidirectional braking structure of a ratchet wrench as claimed in claim 2 further comprising two accommodating spaces, each disposed on the upper and the lower end of the accommodating space of the restricting ring, and each for fixing a restricting ring.

4. A unidirectional braking structure of a ratchet wrench as claimed in claim 3, wherein said restricting ring at its external wall and said restricting ring at the sidewall of its accommodating space each having a C-shape latching groove for being latched by a C-shape latching ring to fix the restricting ring into the space of the restricting ring.

5. A unidirectional braking structure of a ratchet wrench as claimed in claim 4, wherein said work piece wheel at its upper and lower ends having a neck section with substantially the same internal diameter of the restricting ring for being passed into the internal ring surface of the restricting ring.

6. A unidirectional braking structure of a ratchet wrench as claimed in claim 1, wherein said direction restricting member at the end other than the end where the wheel teeth being latched, and the restricting end and the restricting groove having a movable positioning relation.
